(19) United States
(12) Patent Application Publication
(10) Pub. No.: US 2008/0151534 A1
(43) Pub. Date: Jun. 26, 2008

(54) Electronic candle with double light sources

(76) Inventor: Kuo-Lung Lin, Taipei (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/656,456

(22) Filed: Jan. 23, 2007

(30) Foreign Application Priority Data
Dec. 21, 2006 (TW) 095222528

(51) Int. Cl. F21L 4/00

(52) U.S. Cl. 362/191; 362/392

(57) ABSTRACT

An electronic candle with double light sources, includes a rack body having an upper board body. A lower seat body and multiple stands interconnected between the upper board body and the lower seat body. A space being defined between the upper board body and the lower seat body. A transparent main body enclosing the rack body; and a controlling circuit including controlling units, an upper light source and a lower light source. The upper light source is mounted on the upper board body of the rack body, while the lower light source is mounted on the lower seat body of the rack body. After the controlling circuit is triggered, the upper and lower light sources are lighted up according to the way set by the controlling units. When lighted up, the upper light source simulates the flame of a real candle.

### BACKGROUND OF THE INVENTION

1. Field of the Invention

The present invention is related to an electronic candle with double light sources, in which an upper light source is arranged on an upper board body of a rack body, while a lower light source is arranged on a lower seat body of the rack body. When lighted up, the upper light source simulates the flame of a real candle. In addition, the light emitted from the lower light source can go outward through a transparent main body enclosing the rack body. Accordingly, the surroundings of the electronic candle are illuminated to form an ornamental environmental visual effect.

2. Description of the Prior Art

In indoor decoration, lamps or candles are often used to enhance the ambience of a house. However, in case the candle is incautiously tilted down, the flame of the lighted candle tends to ignite other articles to cause a fire. In order to avoid such danger, many kinds of electronic candles have been developed instead of the traditional candles. The electronic candles can project light to simulate the real candles.

The existent electronic candle has a light source at the top. After lighted up, the light source emits light to simulate the flame of a real candle. This can avoid the danger of a fire caused by a real candle. However, such electronic candle can only achieve a limited ornamental effect. In addition, the light emitted from the light source is monotonous. After a period of use, the user will feel bored and the pleasure in using the electronic candle will reduce.

### SUMMARY OF THE INVENTION

It is therefore a primary object of the present invention to provide an electronic candle with double light sources, including: a rack body having an upper board body, a lower seat body and multiple stands interconnected between the upper board body and the lower seat body, a space being defined between the upper board body and the lower seat body; a transparent main body enclosing the rack body; and a controlling circuit including controlling units, an upper light source and a lower light source. The upper light source is mounted on the upper board body of the rack body, while the lower light source is mounted on the lower seat body of the rack body. After the controlling circuit is triggered, the upper and lower light sources are lighted up according to the way set by the controlling units. When lighted up, the upper light source simulates the flame of a real candle. In addition, the light emitted from the lower light source goes outward through the transparent main body to illuminate the surroundings of the electronic candle and create an ornamental environmental rich visual effect.

The present invention can be best understood through the following description and accompanying drawings wherein:

### BRIEF DESCRIPTION OF THE DRAWINGS

FIG. 1 is a perspective view of a first embodiment of the present invention;

FIG. 2 is a sectional view according to FIG. 1;

FIG. 3 is a perspective view of a second embodiment of the present invention;

FIG. 4 is a sectional view according to FIG. 3;

FIG. 5 is a sectional view of a third embodiment of the present invention;

FIG. 6 is a perspective view of a fourth embodiment of the present invention;

FIG. 7 is a perspective view of a fifth embodiment of the present invention;

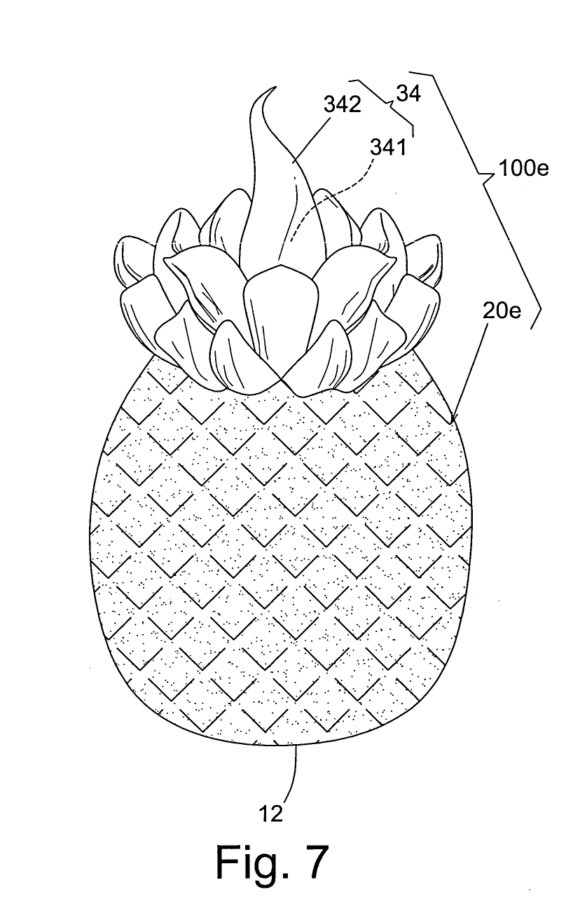

FIG. 8 is a perspective view of a sixth embodiment of the present invention; and

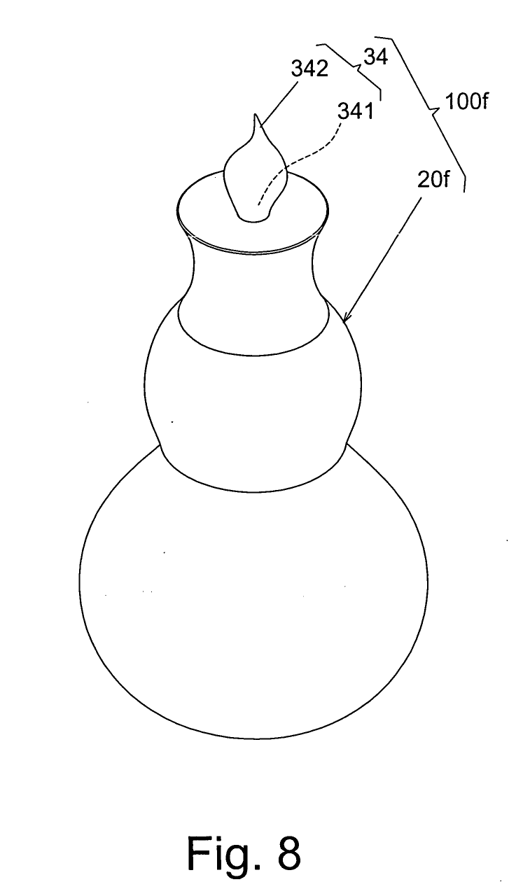

FIG. 9 is a circuit diagram of the controlling circuit of the present invention.

### DETAILED DESCRIPTION OF THE PREFERRED EMBODIMENTS

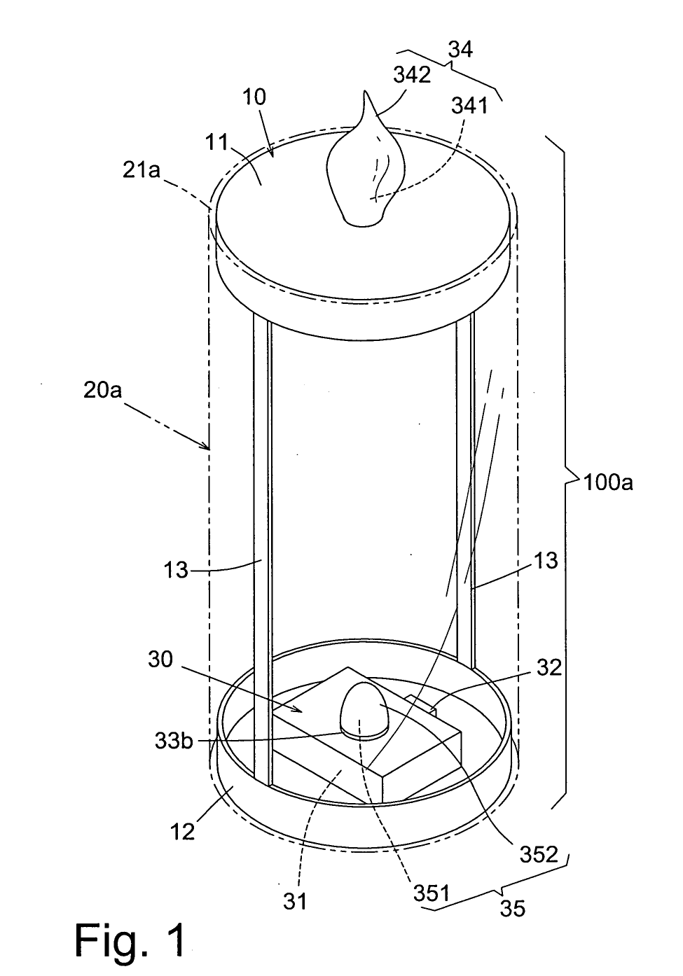

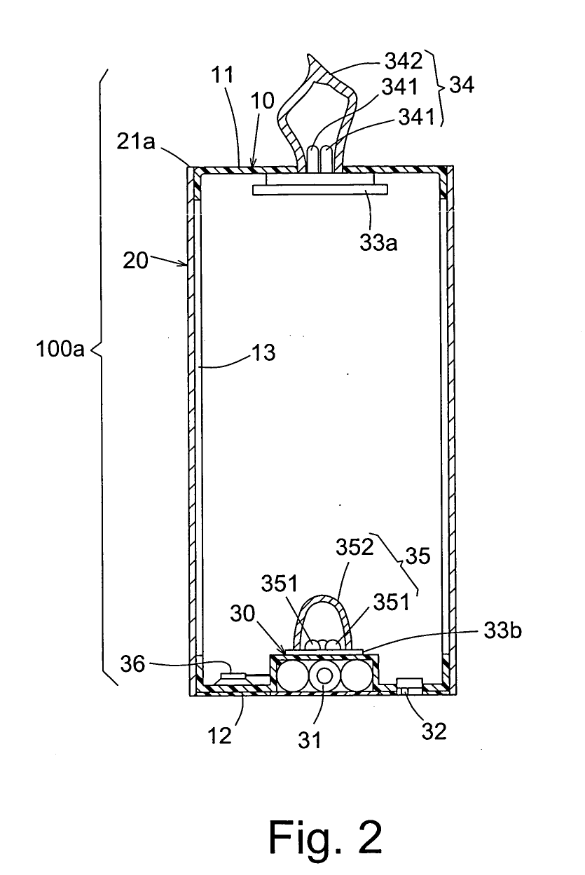

Please refer to FIGS. 1 and 2. The electronic candle 100a with double light sources of the present invention includes a rack body 10, a transparent main body 20a and a controlling circuit 30. The rack body 10 includes an upper board body 11 and a lower seat body 12. Multiple stands 13 are interconnected between the upper board body 11 and the lower seat body 12, whereby a space is defined between the upper board body 11 and the lower seat body 12. The transparent main body 20a encloses the rack body 10. The controlling circuit 30 includes controlling units 33a, 33b, an upper light source 34 and a lower light source 35. The upper light source 34 is mounted on the upper board body 11 of the rack body 10, while the lower light source 35 is mounted on the lower seat body 12 of the rack body 10. After the controlling circuit 30 is triggered, the upper and lower light sources 34, 35 are lighted up according to the way set by the controlling units 33a, 33b. The upper light source 34 is lighted up to simulate the flame of a real candle. In addition, the light emitted from the lower light source 35 can go through the transparent main body 20a to outer side. Accordingly, the surroundings of the electronic candle 100a are illuminated to form an ornamental environmental rich visual effect.

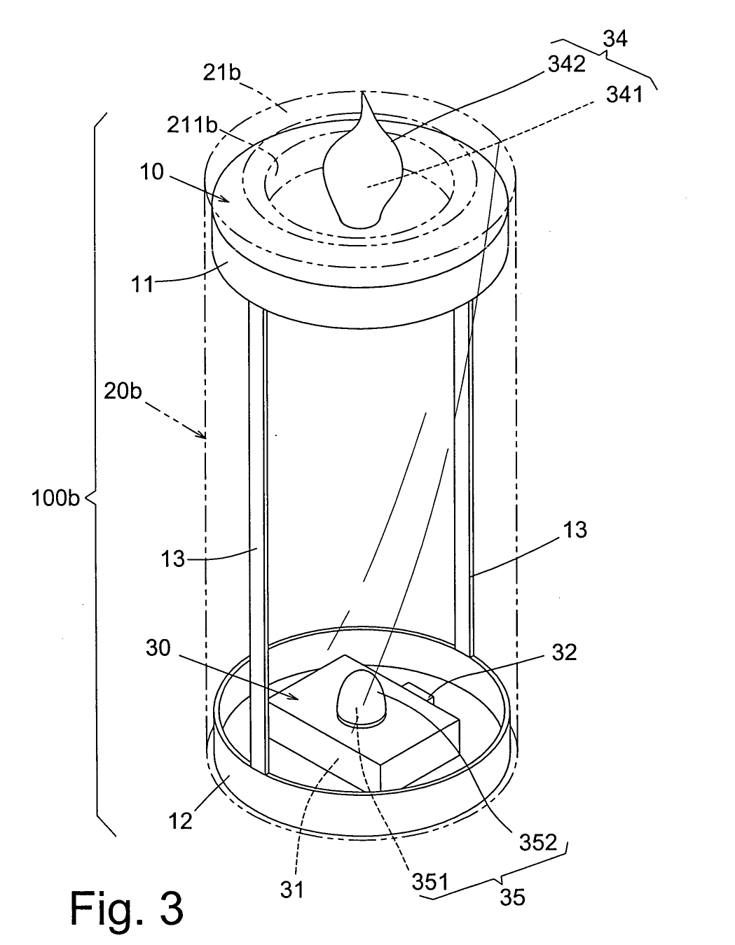

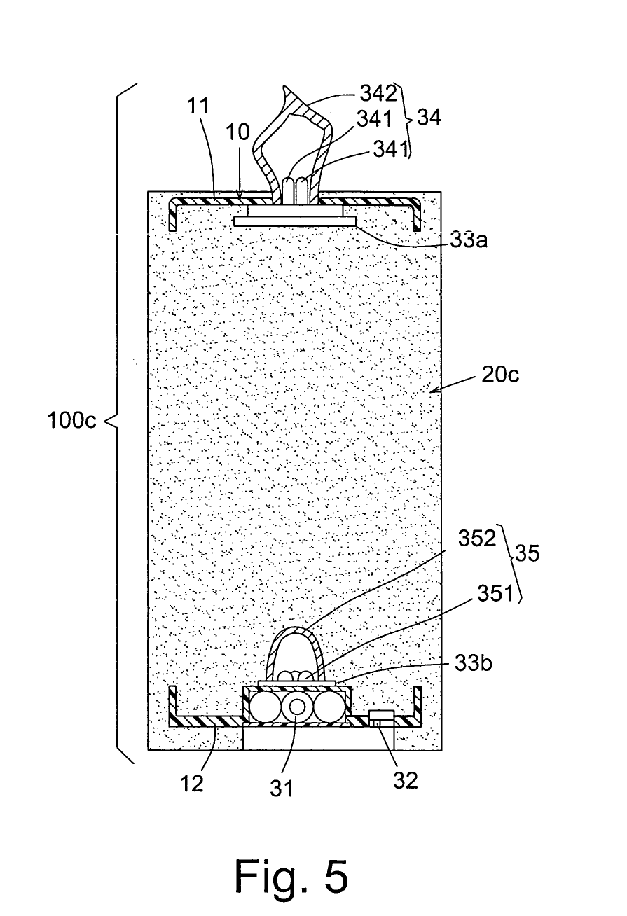

Referring to FIGS. 1 and 3, the transparent main body 20a, 20b of the electronic candle 100a or 100b is a sleeve body enclosing the rack body 10. Alternatively, as shown in FIG. 5, the transparent main body 20c of the electronic candle 100c is made from a transparent wax material to enclose and seal the upper board body 11 and lower seat body 12 of the rack body 10. In this case, the electronic candle has an appearance just like a real candle. Alternatively, the wax material can be simply filled between the upper board body 11 and the lower seat body 12 of the rack body 10.

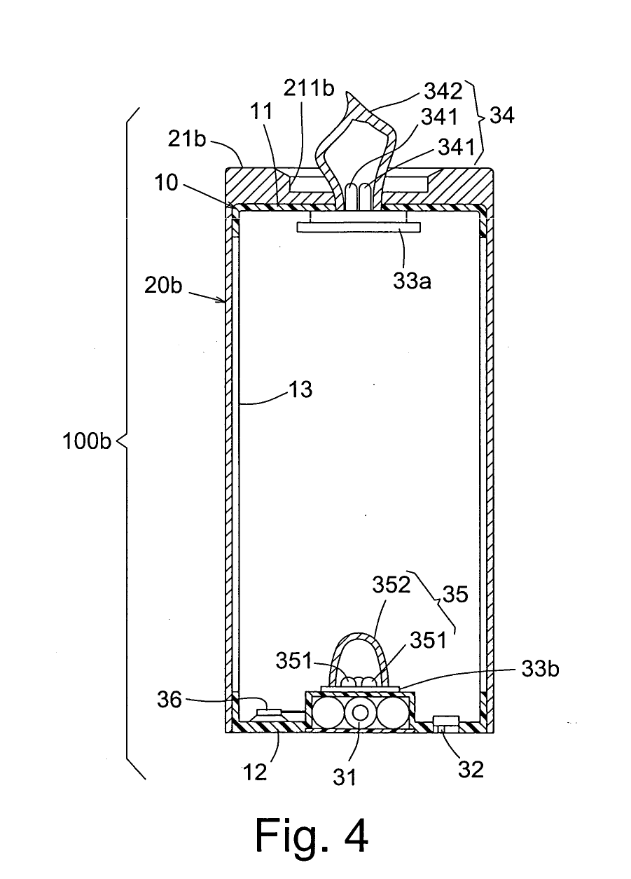

Referring to FIGS. 1 and 2, the transparent main body 20a has an upper end 2 la which does not protrude from the upper board body 11 of the rack body 10. Alternatively, as shown in FIGS. 3 and 4, the upper end 21b of the transparent main body 20b protrudes from the upper board body 11 and covers the upper board body 11. In addition, the center of the upper end 21b of the transparent main body 20b is formed with a depression 211b to simulate a real candle which has been burned for a while.

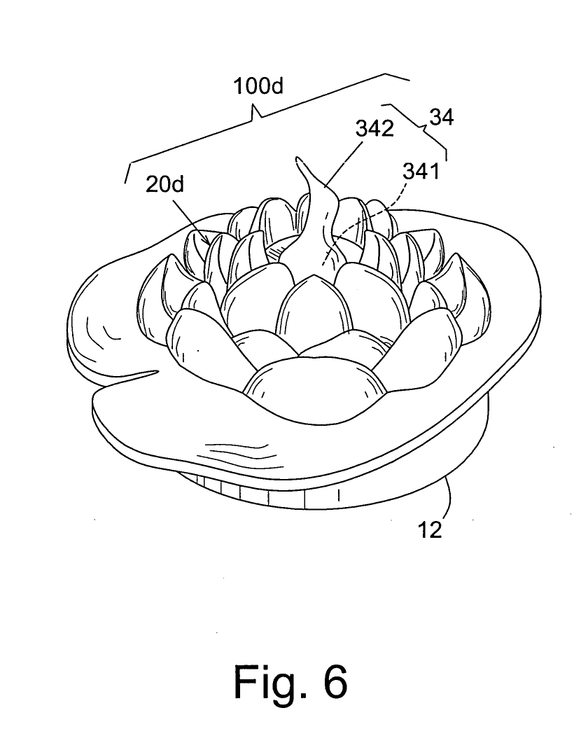

Referring to FIGS. 1 to 5, the transparent main body 20a, 20b, 20c can be a cylindrical shape. Alternatively, as shown in FIG. 6, the transparent main body 20d of the electronic candle 100d has a form of a water lily. Still alternatively, the transparent main body 20e of the electronic candle 100e has a form of a pineapple. Still alternatively, the transparent main body 20f of the electronic candle 100f has a form of a calabash. The appearance and shape of the transparent main body of the present invention are not limited.

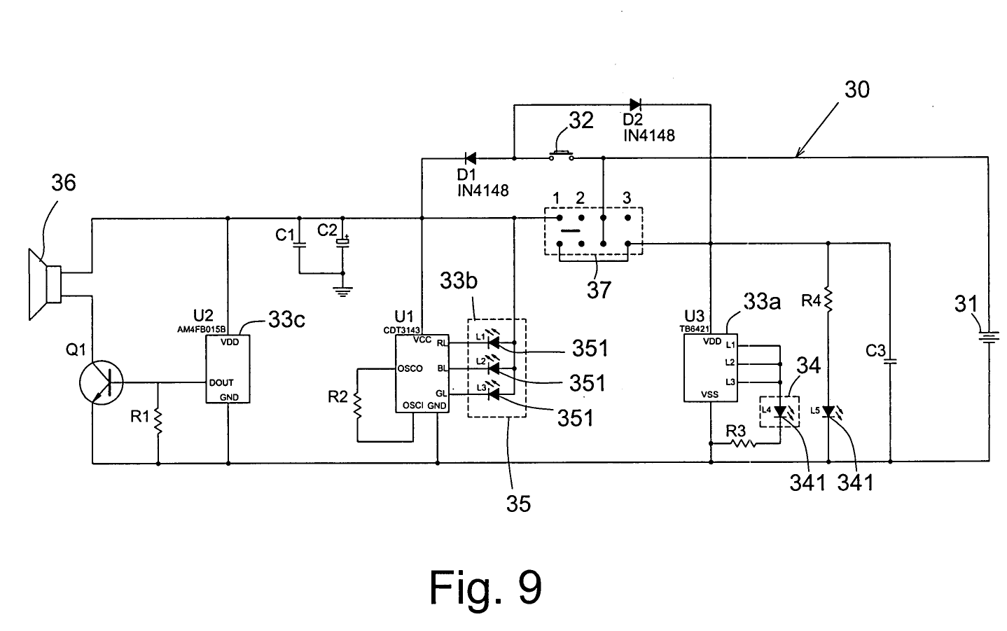

Referring to FIG. 9, the controlling circuit 30 of the electronic candle 100a, 100b, 100c, 100d, 100e, 100f with double light sources of the present invention includes a battery 31, a switch 32 serially connected with the battery 31 and at least one controlling unit 33a, 33b connected with the battery 31. The controlling units 33a, 33b are respectively connected to the upper and lower light sources 34, 35. Each of the upper and lower light sources 34, 35 is composed of at least one light emitter 341, 351 such as light-emitting diode (LED). For example, the lower light source 35 is composed of multiple light emitters 351 capable of emitting different colors of light. When the corresponding controlling unit 33b is triggered, the light emitters 351 with different colors of light are in turn lighted up to illuminate the surroundings. Alternatively, after the controlling circuit 30 is activated, only the controlling unit 33a corresponding to the upper light source 34 is triggered. Accordingly, the upper light source 34 is lighted up. The upper light source 34 can constantly emit light or flicker with the lower light source 35 extinguished. In this case, a different visual effect is achieved.

In the electronic candle 100a, 100b, 100c, 100d, 100e, 100f with double light sources of the present invention, the upper light source 34 of the controlling circuit 30 includes multiple light emitters 341. When lighted up, one of the light emitters is constantly lighted up, while the rest are intermittently lighted up to flicker. Therefore, the brightness is varied as a real flame. Alternatively, the light emitters 341 can flicker in turn. The pattern is not limited.

Referring to FIGS. 2 and 9, in the electronic candle 100a with double light sources of the present invention, the upper light source 34 includes at least one light emitter 341 covered by a transparent shade body 342. The shade body 342 is firmly fixed on the upper board body 11 of the rack body 10. The shade body 342 has a form of a flame. After the corresponding controlling unit 33a is triggered to light up the light emitter 341, the transparent shade body 342 is brightened as a real flame to simulate a burning state.

In the electronic candle 100a, 100b, 100c, 100d, 100e, 100f with double light sources of the present invention, the light emitter 351 of the lower light source 35 is covered by a shade body 352. The light emitted from the light emitter 351 is scattered outward by the shade body 352.

Referring to FIGS. 1 and 9, in the electronic candle 100a with double light sources of the present invention, the controlling circuit 30 further includes an audio controlling unit 33c connected with a buzzer 36. After the audio controlling unit 33c is activated, the buzzer 36 emits music or a voice.

In the controlling circuit 30, a selection switch 37 is further interconnected between the respectively controlling units 33a, 33b, 33c. A user can switch the selection switch 37 to selectively connect the controlling units 33a, 33b, 33c with the circuit or disconnect the controlling units 33a, 33b, 33c from the circuit. Accordingly, the controlling units can controllably turn on/off the corresponding upper light source 34, the lower light source 35 and the buzzer 36. The controlling mode of the circuit is not limited.

The electronic candle 100a, 100b, 100c, 100d, 100e, 100f with double light sources of the present invention is characterized in that the upper light source 34 is arranged on the upper board body 11 of the rack body 10, while the lower light source 35 is arranged on the lower seat body 12 of the rack body 10. When lighted up, the upper light source 34 simulates the flame of a real candle. In addition, the light emitted from the lower light source 35 can go outward through the transparent main body 20a, 20b, 20c, 20d, 20e or 20f enclosing the rack body 10. Accordingly, the surroundings of the electronic candle are illuminated to form an ornamental environmental rich visual effect.

The above embodiments are only used to illustrate the present invention, not intended to limit the scope thereof. Many modifications of the above embodiments can be made without departing from the spirit of the present invention.

What is claimed is:

1. An electronic candle with double light sources, comprising:
(a) a rack body including an upper board body, a lower seat body and multiple stands interconnected between the upper board body and the lower seat body, a space being defined between the upper board body and the lower seat body;
(b) a transparent main body enclosing the rack body; and
(c) a controlling circuit including controlling units, an upper light source and a lower light source, the upper light source being mounted on the upper board body of the rack body, while the lower light source being mounted on the lower seat body of the rack body, whereby after the controlling circuit is triggered, the upper and lower light sources are lighted up according to the way set by the controlling units.

2. The electronic candle with double light sources as claimed in claim 1, wherein the transparent main body is a sleeve body enclosing the rack body.

3. The electronic candle with double light sources as claimed in claim 1, wherein the transparent main body is made from a transparent wax material to enclose and seal the upper board body and lower seat body of the rack body.

4. The electronic candle with double light sources as claimed in claim 1, wherein the transparent main body has an upper end which does not protrude from the upper board body of the rack body.

5. The electronic candle with double light sources as claimed in claim 1, wherein the transparent main body has an upper end protruding from the upper board body and covering the upper board body, a center of the upper end of the transparent main body being formed with a depression.

6. The electronic candle with double light sources as claimed in claim 1, wherein the controlling circuit includes a battery and a switch serially connected with the battery, the battery being connected with the controlling units which are respectively connected to the upper and lower light sources, each of the upper and lower light sources being composed of at least one light emitter.

7. The electronic candle with double light sources as claimed in claim 6, wherein the light emitter of the upper light source is covered by a transparent shade body having a form of a flame.

8. The electronic candle with double light sources as claimed in claim 6, wherein the light emitter of the lower light source is covered by a shade body.

9. The electronic candle with double light sources as claimed in claim 6, wherein the controlling circuit further includes an audio controlling unit connected with a buzzer, whereby after the audio controlling unit is activated, the buzzer emits music or a voice.

10. The electronic candle with double light sources as claimed in claim 6, wherein a selection switch is further interconnected between the respectively controlling units, whereby a user can switch the selection switch to selectively connect the controlling units with the circuit or disconnect the controlling units from the circuit.
